(19) United States
(12) Patent Application Publication
(10) Pub. No.: US 2005/0201927 A1
(43) Pub. Date: Sep. 15, 2005

(54) Process for improving raw pigment grindability

(76) Inventors: Harry E. Flynn, Edmond, OK (US); Robert O. Martin, Edmond, OK (US); Charles A. Natalie, Edmond, OK (US)

Correspondence Address: William B. Miller;Kerr-McGee Corporation, 123 Robert S. Kerr Avenue, Oklahoma City, OK, 73102, US

(21) Appl. No.: 10/798,628

(22) Filed: Mar. 12, 2004

(51) Int. Cl. C01G 23/07

(52) U.S. Cl. 423/613

(57) ABSTRACT

Methods of improving the grindability of raw titanium dioxide produced by high temperature oxidation of titanium tetrachloride comprise quenching the oxidation reaction products with an essentially inert fluid to reduce the degree of aggregation of the titanium dioxide particles and thereby improve the grindability of the raw titanium dioxide. The essentially inert fluid can comprise recycled cooled gaseous reaction products from which the titanium dioxide particles have been separated.

### BACKGROUND OF THE INVENTION

1. Field of the Invention

The present invention relates to an improved oxidation process and improved apparatus for producing titanium dioxide pigment from titanium tetrachloride.

2. Background of the Invention

Titanium dioxide pigment may be produced by various known commercial processes which are familiar to those skilled in this art. In one such commercial process, referred to generally as the “chloride process,” titanium-containing feed material is chlorinated in the presence of a carbon source to produce titanium tetrachloride, carbon dioxide, and other inerts and impurities. The titanium tetrachloride vapor is separated and then oxidized in the vapor phase at elevated temperatures to produce gaseous reaction products and what is commonly referred to as raw titanium dioxide or raw pigment. The gaseous reaction products include chlorine which is recovered and recycled to the chlorination step. The raw titanium dioxide product is recovered, subjected to milling and classification operations and, following treatment to deposit various coatings upon the pigment, subjected to a final milling step to provide a pigment of the desired particle size.

It is well known that titanium tetrachloride reacts with oxygen in the vapor phase to form titanium dioxide and that this reaction is initiated by heating the reactants to a suitable temperature in an oxidation reactor. In this high temperature oxidation reaction step, feed temperatures, reaction temperature, points of titanium tetrachloride and oxygen addition, additives and other variables known to those skilled in the art are adjusted to control product properties such as the primary particle size of the raw titanium dioxide.

Various approaches to controlling the primary particle size of the pigment have been explored. Titanium dioxide nuclei grow in the oxidation reactor via coagulation, coalescence and surface reaction to make pigmentary size particles. At high temperature, the particles will continue to grow rapidly. Previous efforts have focused on halting the growth of primary particles. Initial efforts to control primary particle size included rapid quenching of the hot reaction products as in U.S. Pat. No. 2,508,272 issued to Booge on May 16, 1950. Since then, primary particle size has been controlled by injecting additives such as potassium and alumina, by controlling the initial ratio of oxygen to titanium tetrachloride, and by other methods which result in commercial production of the desired primary particle size. However, even after primary particle growth has essentially been halted, aggregates can continue to form and strengthen due to particle-particle collisions and the temperature in the reactor.

Another approach to particle size control is described in U.S. Pat. No. 5,508,015 issued to Gonzales et al., on Apr. 16, 1996. This approach focuses on injection of a high pressure gas into the oxidizer to increase turbulence and increase the number of particle-particle collisions to thereby increase the amount of agglomeration. The present invention is aimed at achieving the opposite result, i.e., decreasing the number and strength of aggregates to thereby improve the grindability of the aggregates formed.

After oxidation, the raw titanium dioxide and gaseous reaction products are in present practice cooled by passing them through, e.g., a tubular heat exchanger. The raw titanium dioxide particles must then be separated and “finished” prior to being sold as pigment. One of the typical first steps of finishing is milling wherein the raw pigment aggregates are ground back to primary particles. Typically, milling devices such as disc mills, cage mills, and/or attrition mills are used along with a milling medium which must then be completely separated from the titanium dioxide. Milling is both a capital and energy intensive process.

After milling, a surface coating is usually applied to the pigment particles. The coated particles are then dried and subjected to a final milling (micronizing) step. If the aggregates are not reduced to primary particles prior to surface treatment, then total primary particle surface coverage is not possible. Instead, the final micronizing step will reduce the aggregates to primary particles and expose fresh uncoated titanium dioxide surfaces. For this reason as well, any improvement which results in less milling of the pigment prior to surface treatment will be welcomed by industry.

### SUMMARY OF THE INVENTION

The present invention provides improved processes for producing titanium dioxide pigment which meet the needs described above and overcome the deficiencies of the prior art. The present invention, in brief, provides the ability to produce raw titanium dioxide that is less strongly aggregated and more readily ground to primary particles in the subsequent milling step.

A process of the present invention for producing particulate titanium dioxide comprises the following steps. Gaseous titanium tetrachloride is reacted with oxygen in an oxidation reactor to produce particulate titanium dioxide and gaseous reaction products. The particulate titanium dioxide and gaseous reaction products are quenched by injecting an essentially inert (that is, inert as so injected) quench fluid into a zone in the reactor where the reaction is essentially complete and titanium dioxide particles are no longer growing in size. The inert gas is injected at a pressure of less than 75 psig above the reactor pressure and at a temperature significantly less than the temperature of the reaction products at the zone of injection.

A preferred embodiment of the process of this invention for producing particulate solid titanium dioxide comprises the following steps. Gaseous titanium tetrachloride is reacted with oxygen in an oxidation reactor to produce solid particulate titanium dioxide and gaseous reaction products. The particulate titanium dioxide and gaseous reaction products are quenched by injecting recycled gaseous reaction products which have been previously cooled, wherein the cooled recycled gaseous reaction products are injected into a zone in the reactor where the reaction is essentially complete and titanium dioxide particles are no longer growing in size. By providing a thermal quench at this zone in the reactor, the growth and strengthening of titanium dioxide aggregates are diminished and the grindability of the raw titanium dioxide produced is much improved. The recycled gaseous reaction products are injected at a pressure of less than 75 psig above the reactor pressure, and at a temperature significantly less than the reactor temperature at the zone of injection. The quenched particulate titanium dioxide and gaseous reaction products are then further cooled, preferably in a conventional tubular heat exchanger and the cooled particulate titanium dioxide is separated from the cooled gaseous reaction products. A portion of the cooled gaseous reaction product stream is recycled to provide the quench.

The product of the inventive process is a particulate titanium dioxide having improved grindability due to the aggregates being more readily ground to primary particles.

It is, therefore, a general object of the present invention to provide improved processes and apparatus for reacting oxygen and titanium tetrachloride to produce titanium dioxide.

A further object of the present invention is the provision of improved processes for reacting oxygen and titanium tetrachloride to produce raw titanium dioxide pigment wherein the grindability of the titanium dioxide agglomerates produced is significantly improved.

### BRIEF DESCRIPTION OF THE DRAWINGS

FIG. 1 is a diagrammatic view illustrating the present invention.

FIG. 2 is a diagrammatic view illustrating a preferred embodiment of the present invention.

FIG. 3 shows the degree of agglomeration and grindability of quenched raw pigment compared to unquenched raw pigment.

### DESCRIPTION OF PREFERRED EMBODIMENTS

Titanium dioxide (TiO₂), which is useful as a pigment, is produced on a commercial scale by reacting titanium tetrachloride vapor (TiCl₄) with oxygen (O₂) in a reactor to form titanium dioxide particles of a certain desired size and chlorine gas. The reaction takes place at a temperature of about 2200° F. to about 2800° F. Once the primary titanium dioxide particle size has been achieved and the primary particles are no longer growing, particle collisions can still result in partial coalescence and sintering thereby producing titanium dioxide aggregates. A milling step is required to reduce the aggregates back to primary particles prior to surface treatment. It is desirable to reduce the amount of milling required, and this can be achieved by controlling or reducing the coalescence and sintering causing aggregate formation.

In order to control titanium dioxide aggregation without interfering with primary particle growth, it is helpful to understand the reaction mechanisms within the oxidation reactor. Titanium dioxide particles form in the oxidizing reactor by nucleation of particles from the vapor phase. Initially, nucleated particles grow rapidly by condensation as well as coagulation and coalescence. However, once the chemical reaction is complete in a plug flow reactor, no new particles will form and particle growth is limited to coagulation and coalescence. As particles collide, the number of particles per unit volume (particle number density) decreases and particle growth necessarily slows significantly due to fewer collisions.

Further slowing of particle growth occurs due to cooling of the oxidation reactor shell which is required to protect the reactor integrity. As a result, the temperature profile of the reactor decreases well below the melting of the particles a very short distance downstream of the TiCl₄ inlet. The decrease in particle number density and the cooling of the reactor shell, combined with the injection of additives and general design of the reactor, typically result in cessation of primary particle size growth at the desired pigmentary particle size.

The actual primary particle size of the raw pigment is controlled by adjusting a number of oxidizing reactor process variables such as those variables described in U.S. Pat. No. 5,840,112 issued to Morris et al., on Nov. 24, 1998, and in U.S. Pat. No. 6,207,131, issued to Magyar et al., on Mar. 27, 2001, both patents being incorporated herein by reference. For example, the referenced patents teach that particle size and other related properties can be controlled by changing the ratio of titanium tetrachloride to oxygen in the region of the reactor where the titanium dioxide particles start to form or nucleate. This requires a second point of oxygen addition downstream. This secondary oxygen temperature and placement, along with reactor temperature and pressure, can be used to control particle properties.

A number of other methods and additives have also been used to control the primary particle size of the titanium dioxide produced. For example, injection of secondary titanium tetrachloride allows operating flexibility and control and injection of additives such as aluminum chloride, potassium chloride and water provide additional control of primary particle size.

After the primary particles have ceased growing, they can still form aggregates if the particles collide. This occurs in the region of the reactor where the temperature is below the melting point of the particles but above the temperature where particles will sinter. Generally, if the temperature is less than about 80% of the absolute melting temperature, then sintering and agglomeration will not occur. However, a number of other factors, such as particle size distribution, also affect agglomeration and sintering. Smaller particles tend to sinter at lower temperatures than larger particles because of their higher surface energy to volume ratio. The amount of time that a particle spends at a given temperature will also affect the amount of sintering, since sintering is a function of time at a given temperature.

If titanium dioxide particles undergo a relatively slow temperature decrease while in the temperature zone where sintering occurs, undesirable aggregates will form. Such a relatively slow temperature drop occurs when the titanium dioxide and gaseous reaction products are cooled in a smooth round cooling tube or heat exchanger. U.S. Pat. No. 6,419,893 issued to Yuill et al., on Jul. 16, 2002, and incorporated herein by reference, demonstrates that cooling rates can be enhanced by causing the titanium dioxide, gaseous reaction products, and a scouring medium to follow a spiral path through the tubular heat exchanger. The spiral flow increases turbulence and heat transfer rates by removal of deposits from the inside surfaces of the heat exchanger.

The use of heat exchangers is slower than direct cooling or quenching since heat transfer in a gas quench occurs within the gas phase, making a very sharp temperature profile. However, the replacement of heat exchangers with gas quenching requires processing of very large volumes of gas. It is believed that the initial temperature reduction rate is the most important in reducing sintering and improving the grindability of raw titanium dioxide. Therefore, a gas quench step of this invention is preferably included as a supplemental cooling step upstream from the heat exchangers at a zone in the reactor where primary titanium dioxide particles are no longer growing in size but where aggregation would otherwise continue.

A process of the present invention for producing particulate titanium dioxide comprises the following steps. Gaseous titanium tetrachloride is reacted with oxygen in an oxidation reactor to produce particulate titanium dioxide and gaseous reaction products. The particulate titanium dioxide and gaseous reaction products are thermally quenched by injecting an essentially inert quench fluid into a zone in the reactor where the reaction is complete and titanium dioxide primary particles are no longer growing in size. The term “essentially inert quench fluid” means herein that the fluid is essentially chemically inert as injected, i.e., it will not significantly react with the titanium dioxide and gaseous reaction products in the oxidation reactor in the zone and downstream of this zone. The quench fluid provides a thermal quench, or rapid cooling, of the titanium dioxide and gaseous reaction products in the oxidation reactor at the zone of injection.

The essentially inert quench fluid is injected into the reactor at a pressure of less than 75 psig above the reactor pressure and at a temperature significantly less than the temperature of the reaction products at the zone of injection. The quench fluid can be injected into the reactor while in the form of a gas or a liquid. Thus the process of this invention provides a thermal quench to improve the grindability of the titanium dioxide produced by decreasing the formation, growth and strengthening of aggregates.

Preferably, the quenched titanium dioxide particles and gaseous reaction products are further cooled by, immediately after the quench, feeding the particles and gaseous products to a tubular heat exchanger. Generally, addition of a scouring medium to the heat exchanger feed is necessary to remove deposits from the inside surface of the heat exchanger and thereby maintain the heat transfer efficiency. Preferably the titanium dioxide particles and gaseous reaction products are made to follow a spiral path as they flow through the heat exchanger. This spiral path creates more turbulence, improves the removal of deposits from the surface of the heat exchanger, and thus improves the efficiency of the heat exchanger.

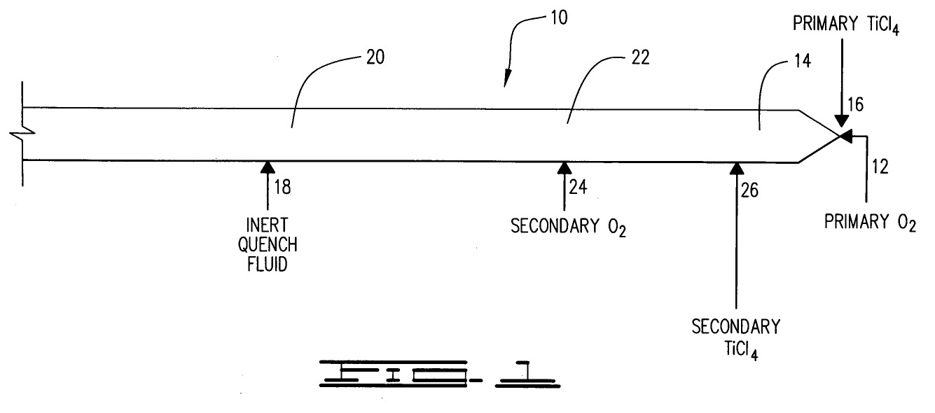

FIG. 1 is a schematic for the quench fluid flow in accordance with the present invention. In general, the oxidation reactor 10 comprises: a first oxidizing gas introduction assembly 12 which is adapted to pass oxygen at a predetermined temperature into the first reaction zone 14 formed in the reactor 10; a first titanium tetrachloride introduction assembly 16 which is adapted to pass titanium tetrachloride vapor at a first predetermined temperature into the first reaction zone 14; and an essentially inert quench fluid introduction assembly 18 which is adapted to pass an essentially inert fluid, at a predetermined temperature significantly lower than reactor temperatures, into the reactor 10 at a point in a quench zone 20.

The reactor is schematically illustrated as a continuous tube (though it need not be so) but can be divided into zones for purposes of discussion. As used herein, the “first reaction zone” 14 refers to the region of the reactor 10 near the first oxygen inlet point 12 where the reaction between TiCl₄ and O₂ is initiated and where TiO₂ particles are nucleated. As used herein, a “second reaction zone” 22 refers to the region of the reactor extending downstream from the first reaction zone 14 and where interparticle reactions occur and the particles grow to the desired size. Downstream of the second reaction zone 22 is the quench zone 20 where primary particles have stopped growing but continue to aggregate and sinter. The sudden temperature reduction resulting from injection of the quench fluid reduces the amount of sintering rendering the raw titanium dioxide much easier to grind to primary particle size.

Often, a second addition of oxygen is introduced into the second reaction zone 22 through a second oxidizing gas introduction assembly 24 at a second predetermined temperature. Also, a second addition of titanium tetrachloride may be introduced into the reactor through a second titanium tetrachloride introduction assembly 26 located within the second reaction zone and can be either upstream or downstream from the secondary oxidizing gas introduction assembly.

Examples of essentially inert fluids that can be used to quench the titanium tetrachloride oxidation reaction products in accordance with this invention (the “quench fluid”) include, but are not limited to, chlorine, nitrogen, carbon dioxide, oxygen, hydrogen chloride, noble gases such as argon, and mixtures thereof. The quench fluid can be obtained from any source including, for example, direct purchase from commercial suppliers of chlorine, on-site production using an inert gas generator, and process streams within the operation. Preferably, the quench fluid comprises the chlorine-containing gaseous reaction products from the oxidation reaction, from which titanium dioxide has been separated, and which are cooled and recycled from downstream steps in the operation.

The temperature of the quench fluid should be significantly less than the temperature of the reactor and the reaction products at the point of injection. The term “significantly less than” as used herein is defined as a temperature difference sufficient, at the volume of quench fluid used, to provide the cooling necessary to achieve a measurable improvement in the grindability of the TiO₂ pigment produced. Preferably the quench fluid has a temperature in the range of about −328° F. to about 200° F., and more preferably from about 32° F. to about 150° F., at the time and point it is injected into the reactor. When the quench fluid is sourced from a process stream within the operation, for example from the chlorine-containing gaseous reaction products from the oxidation reaction, the quench fluid can be cooled via heat exchanging equipment well known to those skilled in the art. In one embodiment of the invention, the quench fluid is an inert gas that has been cooled sufficiently by any conventional means to transform the gas to a liquid phase and the liquid phase is injected into the reactor.

The amount of inert quench fluid injected into the quench zone of the reactor is preferably in the range of from about 0.1 pound to about 5 pounds, and more preferably from about 1 pound to about 2 pounds, per pound of titanium dioxide. Creating a rapid temperature reduction at this particular stage of the reactor, even if the temperature drop is very small, has been found to be beneficial in terms of improving raw pigment grindability. The cooling rate of the titanium dioxide and gaseous reaction products that is provided by the quench is preferably in the range of from about 3,000° F. per second to about 12,000° F. per second.

The inert quench fluid is preferably injected into the reactor at a pressure of from about 0.1 psig to about 75 psig above reactor pressure. More preferably, the inert gas is injected at a pressure of less than about 30 psig above reactor pressure.

The optimum specific location for the reactor quench zone should be determined experimentally to provide the maximum improvement in grindability. In general the quench fluid is injected at a point or points in the reactor that are about 10 ft to 40 ft downstream, more preferably about 10 to 28 ft downstream, and most preferably about 12 ft to 20 ft downstream, of the point in the reactor where oxygen and titanium tetrachloride are first reacted. The actual optimum position will depend on the overall reactor design as well as operating conditions such as feed rate, reaction zone pressure and temperature, space velocity of the reaction products and other operating conditions and variables.

In a preferred embodiment, particulate titanium dioxide and gaseous reaction products are quenched by injecting a recycled stream of gaseous reaction products which have been previously cooled. A portion of the cooled recycled gaseous reaction products is injected into a zone in the reactor where titanium dioxide particles are no longer growing in size. The cooled recycled gaseous reaction products are injected into the reactor at a pressure of less than 75 psig above the reactor pressure and a temperature significantly less than the reactor temperature at the zone of injection. The quenched particulate titanium dioxide and gaseous reaction products are further cooled in tubular heat exchangers and the titanium dioxide particles are separated from the gaseous reaction products in gas-solid separators as will be explained in detail. A portion of the solids-free gaseous reaction product is then recycled as an essentially inert quench fluid, thus providing a thermal quench and thereby improving the grindability of the titanium dioxide produced.

When recycled gaseous reaction product is used as the quench fluid, preferably it has been cooled in the existing process to a temperature in the range of from about 32° F. to about 200° F. prior to injecting into the quench zone of the reactor. In another preferred embodiment, the recycled gaseous reaction product undergoes an additional cooling step, e.g., in a separate heat exchanger, prior to injecting into the reactor. In this case the temperature of the recycled gaseous reaction product at the time and point of injection into the quench zone of the reactor is preferably in the range of from −152° F. to about 150° F. and more preferably from about 32° F. to about 150° F.

Preferably, the recycled gaseous reaction products are injected into the reactor at a pressure of about 0.1 psig to 75 psig above the reactor pressure, and more preferably from about 0.1 psig to about 30 psig above reactor pressure.

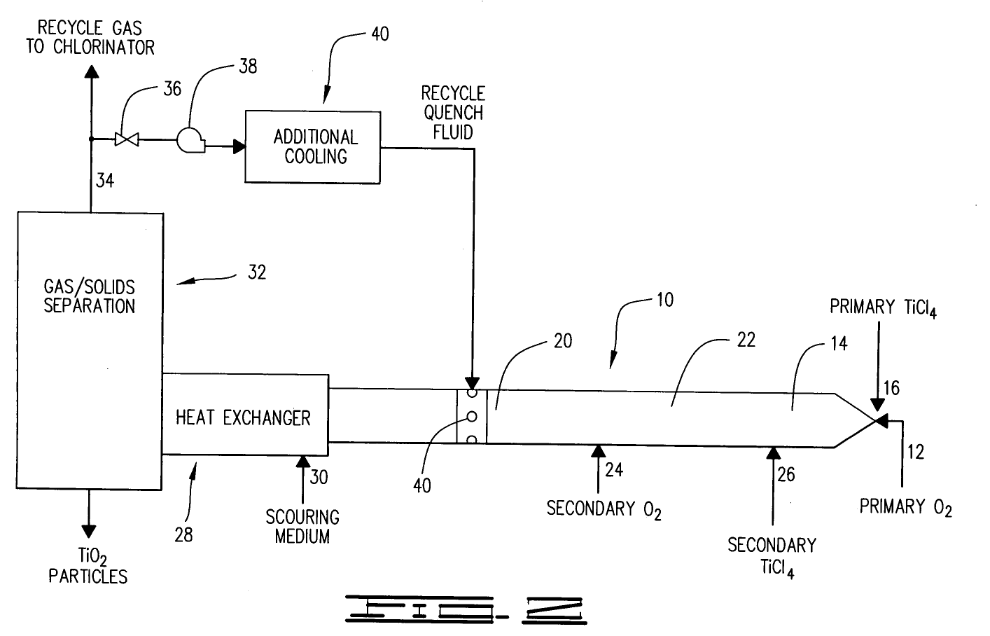

Referring now to FIG. 2, in a preferred embodiment, quenched reaction products, including particulate titanium dioxide and gaseous reaction products, are further cooled in a tubular heat exchanger 28 wherein the reaction products are cooled by heat exchange with a cooling medium such as cooling water. The diameter and length of the tubular heat exchanger varies widely but it is designed to cool the reaction products to a temperature of about 1300° F. or less.

To maintain heat transfer efficiency, a scouring medium introduction assembly 30 is adapted to pass a scouring medium such as sand, fused alumina, sintered titania and the like to remove deposits from the inside surfaces of the heat exchanger. The cooled reaction products are fed to gas-solids separation equipment 32 to separate the scouring medium and particulate titanium dioxide from the gaseous reaction products. Suitable types of gas-solids separation equipment can include, but is not limited to, sand separators, cyclones, bag filters, settling chambers and combinations of these types of equipment.

Cooled solid-free, gaseous reaction products 34 are transferred to the chlorination section of the operation after bleeding a portion of the stream for recycling to the quench section 20 of the oxidizer. The flow of recycled gaseous reaction product is controlled by a valve 36 when the recycled gaseous reaction product pressure is less than about 5 psig above reactor pressure. When a pressure difference greater than about 5 psig is desired, the valve 36 must be replaced or augmented with a blower, centrifugal compressor or other type of gas pump 38. The recycled gaseous reaction product may be additionally cooled and even condensed using a heat exchanger 40. The recycled gaseous reaction product is introduced into the quench section of the reactor through one or more gas injection nozzles 40.

The product of this inventive process is a particulate raw titanium dioxide having improved grindability due to the aggregates being more readily ground to primary particles.

In summary, a process of the present invention for producing particulate titanium dioxide comprises the following steps. Gaseous titanium tetrachloride is reacted with oxygen in an oxidation reactor to produce particulate titanium dioxide and gaseous reaction products. The particulate titanium dioxide and gaseous reaction products are quenched by injecting an essentially inert quench fluid into a zone in the reactor where the reaction is essentially complete and titanium dioxide particles are no longer growing in size. The essentially inert gas is injected at pressure of less than 75 psig above the reactor pressure and at a temperature significantly less than the temperature of the reaction products at the zone of injection.

In order to further illustrate the present invention, the following examples are given.

### EXAMPLE 1

A pilot quench test was run on a single burner line where a portion of the gaseous reaction products, having cooled to 125° F., were recycled and injected back into the reactor at a pressure of less than 5 psig above the reactor pressure at the point of injection. Two recycle gas injection nozzles were located in the reactor about 33.7 feet downstream of the primary titanium tetrachloride slot. The volume of gas recycled represented about 25% of the total gas flow in the reactor. Samples were taken of the raw pigment produced using the recycle gas quench and compared to samples taken prior to addition of the quench.

The degree of agglomeration can be estimated from sieve analyses of the percent passing 0.63 micrometer. Particles having diameters greater than 0.63 micrometer are considered agglomerated. The samples of raw pigment were sand-milled in the laboratory using silica sand. Table 1 below compares the raw pigment milling time required, in minutes, to achieve 95% passing 0.63 micrometer. A comparison of the laboratory milling times to achieve 95% passing 0.63 micrometer shows that the additional quench step reduced the milling required by about 20%.

TABLE 1
Grindability of Raw Pigment Quenched at 33.7 Feet

| Test | Quench Rate | Quench Temp. | Grind Time to 95% |
|---|---|---|---|
| Sample | SCFM | ° F. | <0.63 μm, (min.) |
| 1 | 161 | 78 | 28.3 |
| 2 | 291 | 127 | 28.6 |
| 3 | 300 | 137 | 34 |
| 4 | 296 | 134 | 34.9 |
| 5 | 309 | 122 | 32 |
| 6 | 305 | 124 | 30 |
| 7 | 0 | — | 38 |

### EXAMPLE 2

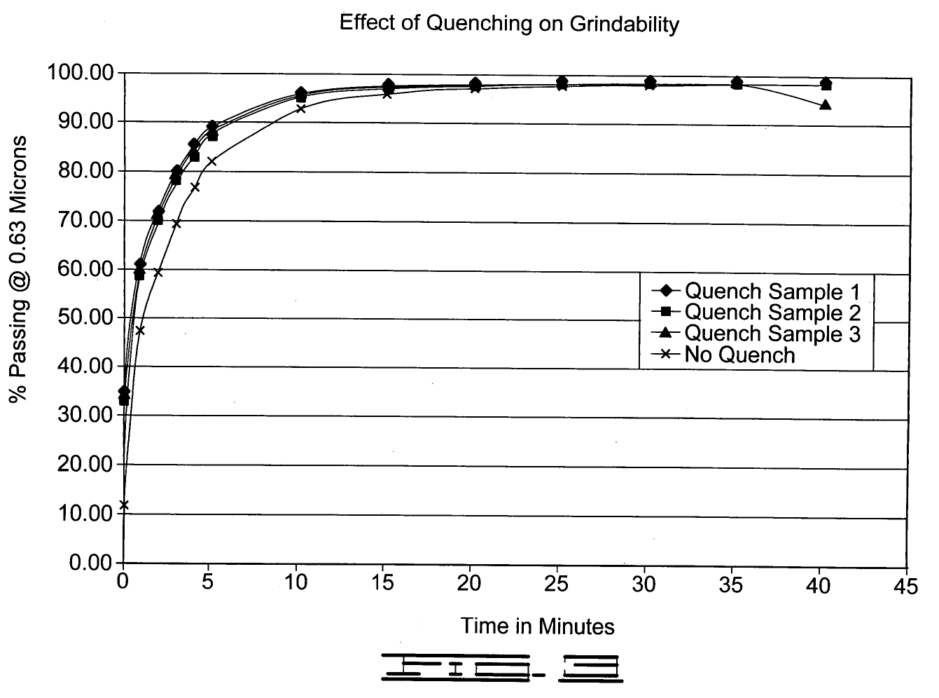

Raw pigment samples from the pilot test described above were sand-milled in the laboratory using zircon sand. FIG. 3 shows the sieve analyses over time for test samples. Without milling, the unquenched raw pigment was about 90% agglomerated compared to the quenched samples which were about 65% agglomerated. As can be seen, the grindability of raw titanium dioxide produced using the additional quench step is consistently improved over the grindability of raw titanium dioxide produced without the quench step.

### EXAMPLE 3

A second pilot quench test was run on a single burner line where a portion of the gaseous reaction products, having cooled to about 130° F., were again recycled and injected back into the reactor. In this test two recycle gas injection nozzles were located in the reactor about 26.2 feet downstream of the primary titanium tetrachloride slot. The volume of gas recycled was increased to about 40% of the total gas flow in the reactor. Samples were taken of the raw pigment produced using the recycle gas quench and compared to samples taken prior to addition of the quench.

The samples of raw pigment were sand-milled in the laboratory using zirconia grinding media rather that silica sand. Zirconia media provides faster and more reliable grind tests. Table 2 below compares the raw pigment laboratory milling time required, in minutes, to achieve 95% passing 0.63 micrometer. A comparison of the laboratory milling times shows that quenching at this position and under the above described conditions reduced the milling required by about 30%.

TABLE 2
Grindability of Raw Pigment Quenched at 26.2 Feet

| Test | Quench Rate | Quench Temp. | Grind Time to 95% |
|---|---|---|---|
| Sample | SCFM | ° F. | <0.63 μm, (min.) |
| 1 | 385 | 136 | 9.9 |
| 2 | 399 | 123 | 9.8 |
| 3 | 389 | 141 | 9.7 |
| 4 | 0 | — | 13.6 |

Thus, the present invention is well adapted to carry out the objects and attain the benefits and advantages mentioned as well as those that are inherent therein. While numerous changes to the compositions and methods can be made by those skilled in the art, such changes are encompassed within the spirit of this invention as defined by the appended claims.

1. A process for producing particulate solid titanium dioxide comprising:
(a) reacting gaseous titanium tetrachloride and oxygen to produce particulate titanium dioxide and gaseous reaction products in an oxidation reactor; and
(b) quenching the particulate titanium dioxide and gaseous reaction products by injecting an essentially inert quench fluid into a zone in the reactor where the reaction is essentially complete and titanium dioxide particles are no longer growing in size, wherein the quench fluid is injected at a pressure of less than 75 psig above the reactor pressure, and at a temperature significantly less than the temperature of the reaction products at the zone of injection.

2. The process of claim 1 further comprising cooling the quenched titanium dioxide particles and gaseous reaction products by passing the quenched titanium dioxide particles and gaseous reaction products through a tubular heat exchanger.

3. The process of claim 2 wherein the quenched titanium dioxide particles and gaseous reaction products are made to follow a spiral path as they flow through the tubular heat exchanger.

4. The process of claim 1 wherein the quench fluid is an essentially inert gas selected from the group consisting of chlorine, nitrogen, carbon dioxide, oxygen, hydrogen chloride, noble gases, and mixtures thereof.

5. The process of claim 1 wherein the quench fluid comprises cooled, recycled gaseous reaction products from which titanium dioxide has been separated in the process.

6. The process of claim 5 wherein the recycled gaseous reaction products have a temperature of from about −152° F. to about 200° F. at the point of injection into the reactor.

7. The process of claim 1 wherein the quench fluid has a temperature of from −328° F. to about 200° F. at the point of injection into the reactor.

8. The process of claim 1 wherein the quench fluid is an essentially inert gas that has been cooled sufficiently to transform to a liquid phase prior to injecting into the reactor.

9. The process of claim 1 wherein the quench fluid is injected into the reactor in an amount of about 0.1 pound to about 5 pounds per pound of titanium dioxide.

10. The process of claim 1 wherein the quench fluid is injected into the reactor at a pressure in the range of from about 0.1 psig to about 75 psig above reactor pressure.

11. The process of claim 1 wherein the quench fluid is injected into the reactor at a point or points in the reactor that are about 10 ft to about 40 ft downstream of the point in the reactor where oxygen and titanium tetrachloride are first reacted.

12. A process for producing particulate solid titanium dioxide comprising:
(a) reacting gaseous titanium tetrachloride and oxygen to produce solid particulate titanium dioxide and gaseous reaction products in an oxidation reactor;
(b) quenching the particulate titanium dioxide and gaseous reaction products with a recycled stream of gaseous reaction products which has been previously cooled by injecting a portion of the cooled recycled stream of gaseous reaction products into a zone in the reactor where the reaction is complete and titanium dioxide primary particles are no longer growing in size, said recycled gaseous reaction products being injected at a pressure of less than 75 psig above the reactor pressure, and at a temperature significantly less than the reactor temperature at the zone of injection;
(c) cooling the quenched particulate titanium dioxide and gaseous reaction products in a tubular heat exchanger;
(d) separating the cooled particulate titanium dioxide from the cooled gaseous reaction products; and
(e) recycling a portion of the cooled gaseous reaction products, from which the titanium dioxide has been removed as in step (d), to the reactor to provide the quench as called for in step (b).

13. The process of claim 12 wherein the recycled gaseous reaction products are at a temperature of about 32° F. to about 200° F. at the point of injection into the reactor.

14. The process of claim 12 wherein the recycled gaseous reaction products are injected into the reactor in an amount of about 0.1 pound to about 5 pounds per pound of titanium dioxide.

15. The process of claim 12 wherein the recycled gaseous reaction products are further cooled using a tubular heat exchanger prior to injecting into the reactor.

16. The process of claim 15 wherein the recycled gaseous reaction products are cooled to a temperature of about −152° F. to about 150° F. prior to injecting into the reactor.

17. The process of claim 12 wherein the recycled gaseous reaction products are injected into the reactor at a pressure in the range of from about 0.1 psig to about 75 psig above reactor pressure.

18. The process of claim 12 wherein the recycled gaseous reaction products are injected at a pressure of less than about 30 psig above reactor pressure.

19. The process of claim 12 wherein the recycled gaseous reaction products are injected into the reactor at a point in the reactor that is about 10 ft to about 30 ft downstream of the point in the reactor where oxygen and titanium tetrachloride are first reacted.
